(19) United States
(12) Patent Application Publication
(10) Pub. No.: US 2010/0263577 A1
(43) Pub. Date: Oct. 21, 2010

(54) POLLUTION ABATEMENT PROCESS FOR FOSSIL FUEL-FIRED BOILERS

(75) Inventor: Pramodh Nijhawan, Knoxville, TN (US)

Correspondence Address: Hovey Williams LLP, 10801 Mastin Blvd., Suite 1000, Overland Park, KS, 66210, US

(73) Assignee: Industrial Accessories Company, Mission, KS (US)

(21) Appl. No.: 12/427,408

(22) Filed: Apr. 21, 2009

(51) Int. Cl. F23J 15/02; B01J 20/04; B01J 20/20; F22B 1/00

(52) U.S. Cl. 110/345; 502/400; 502/417; 110/234; 110/203

(57) ABSTRACT

The present invention provides improved boiler assemblies (10) with enhanced pollution abatement properties through injection and recycling of particulate sorbent materials including sodium bicarbonate, trona, and mixtures thereof. The assemblies (10) include a boiler (12), economizer (14), air heater (15), and recirculation reactor (16). Fresh sorbent material is introduced via assembly (60) into the boiler assembly (10) at one or more injection locations, and serves to sorb NOₓ, SOₓ, and other pollutants in the flue gas. The flue gas and entrained sorbent material then pass through reactor (16) for separation of sorbent, which is then recycled for injection back into the assembly (10) upstream of reactor (16).

The present invention can also be used in industrial applications where the same emissions are generated and are needed to be controlled. Examples of such applications are Cement and Lime Kilns.

### BACKGROUND OF THE INVENTION

1. Field of the Invention

The present invention is broadly concerned with boiler assemblies and methods of operation thereof giving enhanced pollution removal. More particularly, the invention is concerned with such assemblies and methods wherein flesh sorbent material is injected into the assembly and reacts with flue gas pollutants; the flue gas and entrained sorbent are then passed through a recirculation reactor where sorbent is recovered for reinjection into the boiler. The invention provides a high degree of pollution abatement with low cost operation.

2. Description of the Prior Art

In fuel-fired boiler assemblies, and particularly coal-fired power generating plants or other industrial processes, combustion products include many compounds having an adverse influence on boiler operation or are environmentally undesirable and subject to government regulation. Such compounds include sulfur oxides (SOₓ), nitrogen oxides (NOₓ), hydrochloric acid, and heavy metals such as Hg, As, Pb, Se, and Ca. Additionally, a significant number of nations, including the European Union and Japan, have taken steps to further limit the emissions of carbon dioxide.

In order to meet environmental limitations affecting the discharge into the atmosphere of the most prevalent of the widely regulated compounds, sulfur dioxide, combustion products from these plants and processes are commonly passed through flue gas desulfurization (FGD) systems. The treatment of flue gases to capture sulfur dioxide is often accomplished in lime or limestone-based wet, semi-dry and/or dry scrubbers where lime and limestone slurries and/or dry sorbents contact the flue gases before they are discharged to the atmosphere. The sulfur oxides are thereby chemically converted into insoluble compounds in the form of sulfites or sulfates. The sulfur oxides are thus converted into less environmentally harmful compounds which are either disposed of in landfills or treated and sold as marketable chemicals.

The SO₃ emission problem has been addressed chemically using a variety of alkaline chemicals (wet and dry) that are injected into the system at many different points in the flue gas flow path. Lime or limestone injected into the high temperature region of the boiler can also be effective in capturing the SO₃, but the commercial materials that are generally utilized tend to magnify boiler deposit problems and increase the quantity of particulates that can escape. Sodium compounds, such as the bisulfite, carbonate, bicarbonate and sodium sesquicarbonate (Trona) compounds have also been injected into the flue gas stream and are effective in SO₂ and SO₃ capture. Commercially available, but relatively expensive, oil-based magnesium additives can be effective in SO₃ capture. In that regard, one of the most effective chemical techniques for controlling both ash-related fouling in the boiler, and also the corrosion and emission problems associated with SO₃ generated in solid-field boilers, is the injection into the upper region of the boiler of oil slurries of MgO or Mg(OH)₂. That technology was originally developed for use with oil-fired boilers in which the magnesium-based oil suspension was usually metered into the fuel. It was later applied to coal-fired boilers. The most widely accepted mode of application of such additives today is by injection of slurries of MgO or Mg(OH)₂ into the boiler above the burners and just below the region at which a transition from radiant heat transfer to convective heat transfer occurs.

Another approach to SO₃ capture involves the use of so-called “overbased” organic-acid-neutralizing additives of the type that are included in motor oils and as fuel oil combustion additives. Those additives are actually colloidal dispersions of metallic carbonates, usually magnesium or calcium. When burned with the fuel, they are effective at near stoichiometric dosage in capturing SO₃ and in mitigating ash deposits caused by vanadium and/or sodium in the oil. The colloids are stabilized by carboxylic or sulphonate compounds and are known to provide mostly particles in the Angstrom range. Though very expensive, the “overbased” compounds are widely used at low dosages to capture vanadium in heavy-oil-fired combustion turbines.

In addition to oil-based slurries, Mg(OH)₂ powders and water-based slurries have also been utilized as fireside additives in boilers, but because of their generally coarser particle size they are less efficient in capturing the SO₃. Water slurries of MgO have also been injected through specially modified soot blowers installed on oil and Kraft-liquor-fired boilers, in which they moderated high temperature deposits but had only a nominal impact on SO₃-related problems because of an inability to apply the chemicals continuously.

In addition to limitations on SOₓ emissions, regulations aimed at controlling mercury emissions from coal-fired boilers have been promulgated by regulatory authorities, and regulations applicable to other toxic metals are anticipated eventually. A considerable amount OF research aimed at finding practical techniques for capturing such toxic metals has shown that high-surface-area solids can capture a significant portion of mercury by adsorption, if the mercury is in an oxidized form rather than in an elemental form. Oxidants, either added to or naturally present in the fuel, such as chlorides, can facilitate the oxidation. Although high-surface-area lime can be effective in mercury capture, the usual commercial products can result in operational problems in the form of ash deposits and increased stack emissions. The most widely accepted way to achieve mercury capture has been the injection of expensive activated carbons in the cooler regions of the boiler gas path.

In addition, a variety of bromides and related compounds (e.g., iodates) have been used for control of mercury in boiler flue gasses, alone or in combination with activated carbon, clays, zeolites, and fly ash.

References describing the use of a plurality of inorganic carbonates, hydroxides and oxide compounds for boiler pollution abatement include: US Publications Nos. 2008/0286183; 2008/0233028; 2006/0005750; U.S. Pat. Nos. 6,528,030; 4,983,187; 4,824,441; 4,801,438; 4,783,197; 4,562,054; 4,522,626; 4,515,601; 4,226,601; 4,192,652; 4,148,613; 3,970,434; and German Patent No. DE 3,317,504.

Prior references which disclose the use of at least two carbonate, hydroxide or oxide compounds include: US Publications Nos. 2008/0060519; 2006/0034743; U.S. Pat. Nos. 7,276,217; 7,013,817; 5,505,746; 5,458,659; 5,350,431; 4,555,390; 4,280,817; 4,274,836; 4,092,125; and 4,055,400.

References teaching the use of single carbonates, hydroxides or oxides include: US Publications Nos. 2008/0279743; 2004/0202594; 2002/0050094; U.S. Pat. Nos. 7,374,590; 7,056,359; 5,368,617; 4,886,519; 4,574,045; 4,516,980; 4,423,702; 4,395,975; 4,305,728; and 4,302,207.

References describing the use of bromide compounds for removal of mercury with or without other inorganic components include: US Publications Nos. 2008/0182747; 2008/0134888; 2008/0121142; 2008/0115704; 2007/0180990; 2006/0205592; 2006/0204418; 2006/0185226; 2004/0086439; 2004/0003716; U.S. Pat. No. 6,878,358; PCT Publication No. WO 2006/101499; US Publications Nos. 2008/0207443; 2008/0127631; 2006/0210463; 2003/0161771; U.S. Pat. Nos. 4,859,438; 4,663,136; 4,233,175; and 4,115,518.

The longstanding pollution abatement technologies employed with fossil fuel-fired boiler assemblies, while useful to a certain degree, do not achieve the highest degree of pollution control. Moreover, the prospect of increasingly stringent government pollution regulations makes it imperative that improved technologies be provided. It is the aim of the present invention to remedy this problem.

### SUMMARY OF THE INVENTION

The present invention overcomes the problems outlined above and provides improved boiler assemblies and methods characterized by a high degree of pollution abatement and low-cost operation. The boiler assemblies generally include a fossil fuel inlet, a boiler chamber coupled with the fuel inlet to receive fossil fuel for burning thereof, an economizer assembly comprising an inlet coupled with the boiler, an economizer chamber, and an economizer outlet, an air heater coupled with the economizer outlet, and a recirculation reactor coupled with the air heater.

In operation, a pollution sorbent material including a member selected from the group consisting of sodium bicarbonate, trona and mixtures thereof is provided at a normalized stoichiometric ratio of from about 0.2-3 based upon the level of sulfur in the fossil fuel. Fresh sorbent material is introduced into the boiler assembly at least one injection point during the burning of the fossil fuel in the boiler, thereby causing the material to sorb at least some of the sulfur pollutants created during the burning of the fossil fuel, and creating a stream of hot flue gas and entrained sorbent material which passes through the assembly and ultimately into the recirculation reactor. In the recirculation reactor, at least some of the entrained sorbent material is recovered and is injected back into the boiler assembly at a recovered sorbent injection point upstream of the recirculation reactor. The boiler assembly is operated so as to maintain the temperature of the hot flue gas passing from the recirculation reactor at a temperature of at least about 25° F. above the adiabatic saturation temperature of the flue gas, and such that the retention time of the hot flue gas passing through the recirculation reactor is from about 1-4 seconds.

The fresh and recovered sorbent material injection points may be the same (e.g., into the boiler of the assembly) or may be different. Preferably, both the fresh and recovered sorbent are injected through the use of plural high pressure injection lances extending into the assembly.

The sorbent material for use in a given boiler assembly is custom-designed depending upon the characteristics of the fossil fuel and operating conditions. For example, if Hg is present in the fuel, bromide compounds may be used. The sorbent material is advantageously in fine particulate form, and typically has an average particle diameter in the range of 20 to 50μ.

For multi-pollutant emission control, a mixture of sorbents can be created to provide control of SO3; SO2; Hg; As and/or other toxic emissions, The mixture of calcium bromide and magnesium or sodium-based compounds is often preferred, especially a mixture including a pollution sorbent material for injection into a fuel-fired boiler assembly to remove Hg emissions from the boiler assembly, said material including therein calcium bromide, sodium carbonate, and a member selected from the group of trona, magnesium oxide, and mixtures thereof. Calcium bromide will remove the Hg emissions when SO₃ is not in the flue gas. The quantities of use will be determined by the degree of control required. This design can also be incorporated into various industrial applications, such as cement and lime kilns. When use is made of such sorbent material, it can be introduced into a boiler assembly with the use of a recirculation reactor or without any such recovery and recirculation.

In other embodiments, the sorbent materials of the invention may be introduced or injected with appropriate quantities of powdered activated carbon (PAC). In this way, the requisite amounts of PAC can be minimized.

### BRIEF DESCRIPTION OF THE DRAWINGS

FIG. 1 is a schematic representation of an exemplary coal-fired boiler assembly employing the invention;

FIG. 2 is a schematic view partially in section illustrating the design and hook-up of the preferred recirculation reactor of the invention; and

FIG. 3 is a sectional view taken along line 3-3 of FIG. 2 and depicting the orientation of the preferred injection lances for injection of fresh sorbent, and for injection of recovered sorbent material from the recirculation reactor back into the boiler assembly.

### DETAILED DESCRIPTION OF THE PREFERRED EMBODIMENT

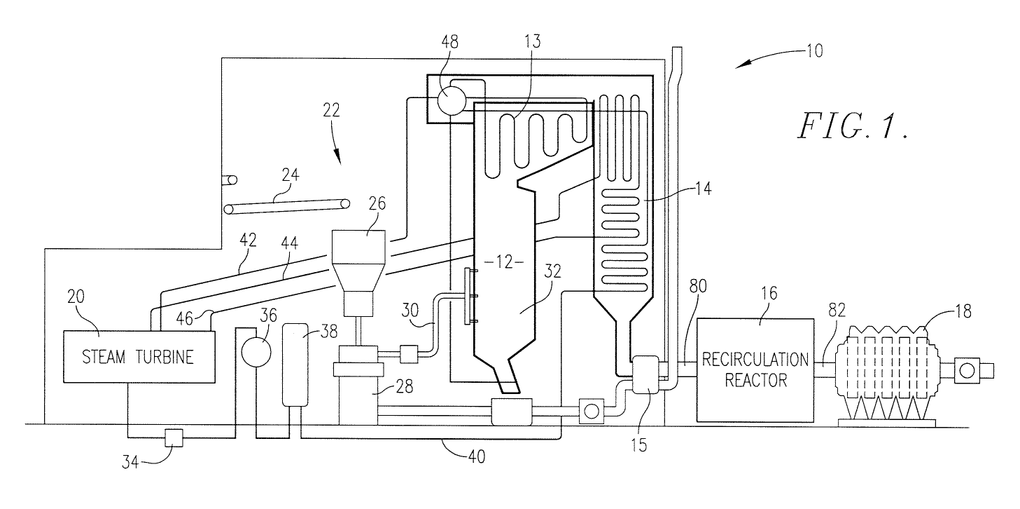

Turning now to the drawings, and particularly FIG. 1, an exemplary fossil fuel-fired boiler assembly 10 is schematically depicted in FIG. 1. Broadly speaking, the assembly 10 includes a boiler 12 including a superheater 13, economizer 14, air preheater 15, recirculation reactor 16, and a precipitator 18 (which can also be baghouse or other particulate collector) leading to a flue gas stack (not shown). The assembly 10 further has a steam turbine 20 (typically comprising interconnected low, intermediate and high pressure turbines), and a coal delivery assembly 22. The latter has a coal conveyor 24, coal hopper 26, coal pulverizer 28, and coal injector 30 operable to inject pulverized coal into the chamber 32 of boiler 12. A feedwater pump 34, the aerator 36 and heater 38 are located within feedwater line 40 leading to the economizer 14. Separate steam lines 42, 44, and 46 respectively extend between steam turbine 20 and boiler steam drum 48, and between the turbine 20 and economizer 14 as shown. An electrical generator and transformer is also operably coupled with turbine for power generation.

In broad outline, pulverized coal (and/or other solid and/or biomass fuel) is fed into chamber 32 where combustion occurs, creating hot flue gas. This gas passes in serial order through superheater 13, economizer 14, air preheater 15, recirculation reactor 16, and precipitator 18. The thermal energy created by this combustion drives steam turbine 20 to thus generate electricity.

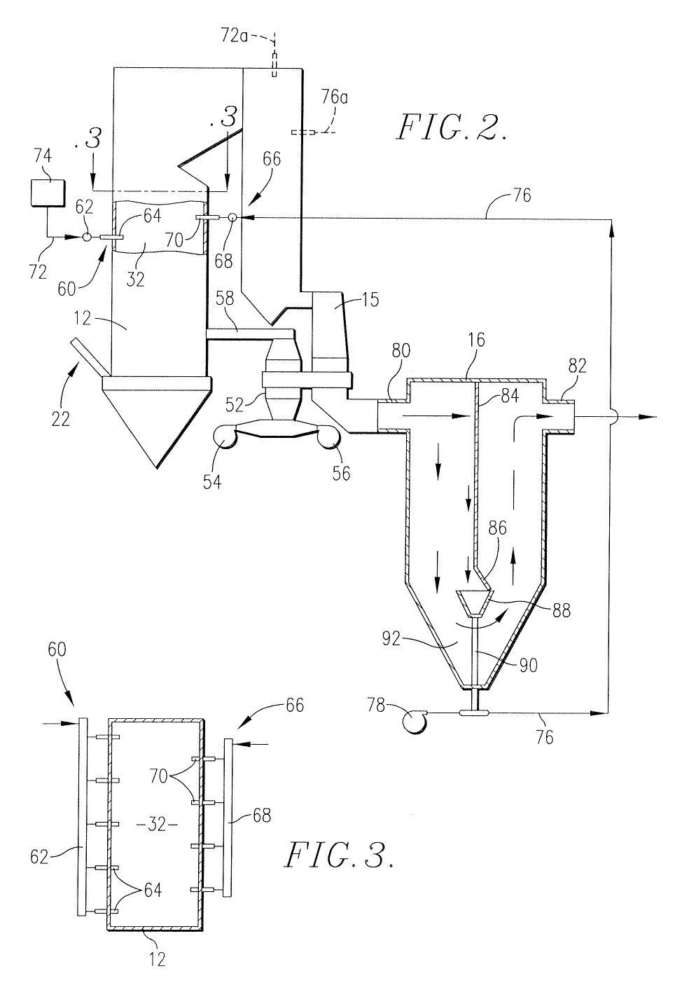

As noted above, pollution abatement in assembly 10 is a critical feature, especially in the context of removing SOₓ gases and any heavy metals such as Hg and As. To this end, the present invention contemplates an improved injection/recirculation assembly 50 illustrated in FIGS. 2-3. As illustrated, the air preheater 15 in this design has a secondary air assembly 52 equipped with forced draft fans 54 and 56, with the assembly 52 also supplying positive pressure air to the windbox of boiler 12 via conduit 58. Also, the assembly 50 provides a fresh sorbent material injection assembly 60 in the form of a manifold 62 and a plurality of individual, spaced apart injection lances 64 extending into chamber 32 (FIG. 3). A recovered sorbent material injection assembly 66 is also provided which is likewise in the form of a manifold 68 and a plurality of individual, spaced apart injection lances 70. A fresh sorbent material conveying line 72 extends from a source of fresh sorbent 74 to the manifold 62. A recovered sorbent material recirculation line 76 extends from the bottom of reactor 16 to manifold 68. An eductor 78 serves to generate an airstream for conveying of recovered sorbent material through line 76.

The reactor 16 includes and inlet 80 coupled with air heater 15 as well as an outlet 82 leading to precipitator 18. Internally, the reactor 16 has an upright baffle wall 84 having a lowermost oblique section 86 leading to an open-top collector 88. The collector 88 has a vertically extending outlet tube 90 passing through the bottom of reactor 16 and in communication with eductor 78 and line 76. The region 92 below collector 88 is open so as to permit flow of gas from inlet 80 downwardly through the reactor 16 and upwardly for passage through outlet 82.

In practice, fresh sorbent from source 74 is fed at a controlled rate through line 72, manifold 62 and lances 64 for injection into chamber 32. The injected fresh sorbent is designed to sorb objectionable pollutants created during the combustion process, and especially SOₓ gases and heavy metals. Owing to the need to remove the maximum extent of such pollutants, the fresh sorbent is normally injected in a normalized stoichiometric ratio of from about 0.2-3, more preferably from about 1-2.5, based upon the level of sulfur and/or mercury in the coal or other fossil fuel. Consequently, some of the sorbent is entrained within the hot flue gases created within chamber 32 and passes with these gases through the system to recirculation reactor 16. In the reactor 16, the stream of hot flue gas and entrained sorbent material encounters baffle wall 84, thereby diverting the gas downwardly and facilitating gravitational separation of the entrained sorbent material from the gas. Such separated material is collected in collector 88 and passes downwardly through pipe 90. Thereupon, the recovered sorbent material is conveyed by positive pressure through line 76 to manifold 68 and lances 70 for injection back into chamber 32. In this fashion, much greater pollution abatement efficiencies are obtained, as compared with simple injection of fresh sorbent material.

Although the assembly 50 has been illustrated in FIGS. 2-3 with injection of both fresh and recovered sorbent material into the chamber 32, the invention is not so limited. Thus, the injection of fresh sorbent can occur at one or more material injection points throughout the assembly 10, e.g., points selected from the group consisting of the fossil fuel injector 30 (which includes any point in the coal delivery assembly 22), the boiler chamber 32, the economizer assembly 14, the recirculation reactor 16, and conduit structure between any of these components. In like manner, the injection of recovered sorbent material can be carried out at one or more recovered sorbent injection points anywhere upstream of reactor 16, such as those selected from the group consisting of the fossil fuel injector 30 as defined above, the boiler chamber 32, the economizer assembly 14, and conduit structure there between. While the fresh and recovered sorbent material can be injected at the same points, often they will be injected at different points within the boiler assembly 10. Exemplary alternate injection points for the fresh and recovered sorbent materials are illustrated in FIG. 2 at 72a and 76a.

In particularly preferred embodiments, the injection lances 64 and 70 are spaced apart and often are oriented in multiple, vertically spaced apart rows. Additionally, the respective lances may be inserted into the assembly 10 at varying depths depending upon the operational characteristics of the assembly. Although it would be possible to mix the fresh and recovered sorbent materials, in preferred practice these are separately injected. The lance injections are advantageously carried out at stream velocities of at least about 3,000 ft./min., and more preferably at least about 4,500 ft./min., with lance exit pressures greater than 1 psi at the bases of the lances.

The operation of the recirculation reactor 16 is preferably carried out under boiler assembly operating conditions assuring that the temperature of the hot flue gas passing from the recirculation reactor through outlet 82 is at a temperature of at least about 25° F. (more preferably at least about 50° F.) above the adiabatic saturation temperature of the flue gas. Further, the retention time of the hot flue gas passing through the recirculation reactor is from about 1-4 seconds, preferably from about 1-3 seconds.

The sorbent materials useful in the invention include a member selected from the group consisting of sodium bicarbonate, trona, and mixtures thereof at a normalized stoichiometric ratio of 0.2-3, based upon the level of sulfur in the starting fossil fuel. For mercury control, the sorbent is mixed with calcium bromide in an engineered proportion. In addition however, a given sorbent material will typically be custom-designed for the particular types of pollutants present in the fuel and/or generated during combustion. Other common ingredients in such sorbent materials would be calcium oxide, calcium hydroxide, and calcium carbonate; magnesium oxide and magnesium hydroxide; calcium bromide, magnesium bromide, and sodium bromide. Where calcium and magnesium compounds are employed, they are each commonly used at a normalized stoichiometric ratio of from about 0.2-2 (more preferably from about 0.5-1) based upon fuel sulfur content. Where mercury removal is an issue, bromides are normally used at a level of from about 2-15 lbs. (more preferably from about 5-10 lbs.) per ton of incoming fuel feed.

The sorbent materials useful in the invention are preferably provided as heterogeneous fine powders to facilitate dispersion thereof and ultimate sorbing and/or reaction of pollutants. Generally, the individual ingredients making up the sorbent materials should have an average particle size of up to about 200%, more preferably up to about 50μ. It is also preferred to have varying average particle sizes depending upon the injection site for the fresh sorbent material. Hence, the fresh sorbent material should have an average particle size of up to about 100μ when introduced at the fuel inlet, an average particle size of up to about 50μ when introduced into the boiler chamber, an average particle size of up to about 50μ when introduced into the economizer assembly, and an average particle size of up to about 50μ when introduced into the recirculation reactor.

The invention is applicable to virtually all types of fossil fuel-fired boiler and like assemblies including lime and cement kiln and incinerators. Representative examples include stoker furnaces, cyclone furnaces, pulverized coal furnaces, and fluidized-bed furnaces, which may utilize a variety of boiler systems including fire tube, water tube, water-cooled integral furnace, and once-through boilers.

Numerous advantages are realized through use of the present invention. First and foremost is the advantage of enhanced pollution abatement, stemming from reduction of NOₓ, and SOₓ emissions, as well as Mercury and heavy metal emissions. The use of a recirculation reactor in accordance with the invention maintains essentially a fixed amount of sorbent material in continuous circulation, which helps control emissions and also minimizes sorbent costs. When the circulating sorbent reacts with SOₓ gases, sulfates form on the outer layers of the sorbent particles. The inner core of the particles remains unreacted, and will thereafter fracture, exposing further fresh sorbent for additional reaction.

I claim:

1. A method of reducing pollution emitted from a fuel-fired boiler assembly including a fuel inlet, a boiler chamber coupled with said fuel inlet to receive fuel for burning thereof, an economizer assembly comprising an inlet coupled with said boiler, an economizer chamber, and an economizer outlet, an air heater coupled with the economizer outlet, and a recirculation reactor coupled with said air heater, said boiler assembly operable to deliver an output flue gas from said air heater, said method comprising the steps of:
providing a pollution sorbent material including a member selected from the group consisting of sodium bicarbonate, trona, and mixtures thereof at a normalized stoichiometric ratio of from about 0.2-3 based upon the level of sulfur in said fuel;
introducing fresh sorbent material into said boiler assembly during said burning of said fuel therein, said fresh sorbent material introduction occurring at least one fresh material injection point, causing said material to sorb at least some of the sulfur pollutants created during the burning of said fuel, and creating a stream of hot flue gas and entrained sorbent material passing into said recirculation reactor; and
recovering at least some of said entrained sorbent material from said stream passing into and through said recirculation reactor, and injecting at least some of said recovered sorbent material into a recovered sorbent injection point, said recovered sorbent material injection step including the step of operating said boiler assembly so as to maintain the temperature of the hot flue gas passing from said recirculation reactor at a temperature of at least about 25° F. above the adiabatic saturation temperature of the flue gas, and such that the retention time of the hot flue gas passing through the recirculation reactor is from about 1-4 seconds.

2. The method of claim 1, said fresh material injection point being the same as said recovered material injection point.

3. The method of claim 2, said fresh material injection point and said recovered material injection point being at said boiler chamber.

4. The method of claim 1, said fresh material injection point being different than said recovered material injection point.

5. The method of claim 1, said retention time being from about 1.5-3 seconds.

6. The method of claim 1, said sorbent material including one or more compounds selected from the group consisting of compounds of Br, Mg, Ca, and mixtures thereof.

7. The method of claim 1, said temperature being at least about 50° F. above the adiabatic saturation temperature of the hot gasses.

8. The method of claim 1, including the step of diverting said stream within said recirculation reactor to enhance gravitational separation of said entrained sorbent material from said hot gas.

9. The method of claim 1, including the step of injecting said fresh sorbent material and said recovered sorbent material through separate, individual injection lances.

10. The method of claim 9, including the steps of injecting said fresh sorbent material and said recovered sorbent material at lance velocities of at least about 3,000 ft./min.

11. The method of claim 10, said lance velocities being at least about 4,500 ft./min.

12. The method of claim 1, said normalized stoichiometric ratio being from about 1-2.5.

13. The method of claim 1, said fresh sorbent material having an average particle size of up to about 200μ.

14. The method of claim 13, said flesh sorbent material having an average particle size of up to about 100μ when introduced at said fossil fuel inlet, an average particle size of up to about 50μ when introduced into said boiler chamber, an average particle size of up to about 50μ when introduced into said economizer assembly, and an average particle size of up to about 50μ when introduced into said recirculation reactor.

15. The method of claim 1, said fresh material injection point selected from the group consisting of said fossil fuel inlet, said boiler chamber, said economizer assembly, said recirculation reactor, and conduit structure there between.

16. The method of claim 1, said recovered sorbent material injection point selected from the group consisting of said fossil fuel inlet, said boiler chamber, said economizer assembly, and conduit structure there between.

17. The method of claim 1, said boiler assembly being a coal-fired boiler assembly.

18. The method of claim 1, said sorbent material also including magnesium oxide and calcium bromide.

19. A fuel-fired boiler assembly comprising:
a fuel inlet;
a boiler chamber coupled with said fuel inlet to receive fuel for burning thereof;
an economizer assembly comprising an inlet coupled with said boiler, an economizer chamber, and an economizer outlet;
an air heater coupled with said economizer outlet,
a recirculation reactor coupled with said air heater and having a recirculation reactor outlet;
said boiler assembly operable to deliver an output flue gas from said air heater;
a fresh sorbent material injection assembly operably coupled with said boiler assembly in order to introduce fresh sorbent material into said boiler assembly during said burning of said fuel therein;
said fresh sorbent material operable to sorb at least some of the sulfur pollutants created during the burning of said fuel in said boiler assembly,
said boiler assembly creating during the burning of said fuel therein a stream of hot flue gas and entrained sorbent material, said stream passing into and through said recirculation reactor,
said recirculation reactor operable to separate and recover at least some of said entrained sorbent material from said hot flue gas; and
a recovered sorbent material injection assembly operably coupled with said boiler assembly in order to inject recovered sorbent material from said recirculation reactor at least one recovered sorbent material injection point.

20. The boiler assembly of claim 19, fresh material injection point being the same as said recovered material injection point.

21. The boiler assembly of claim 20, said fresh material injection point and said recovered material injection point being at said boiler chamber.

22. The boiler assembly of claim 19, said fresh material injection point being different than said recovered material injection point.

23. The boiler assembly of claim 19, said recirculation reactor including the an upright wall operable to divert said stream within said recirculation reactor to enhance gravitational separation of said entrained sorbent material from said hot gas.

24. The boiler assembly of claim 19, said fresh sorbent material introduction assembly and said recovered sorbent material introduction assembly each having a plurality of sorbent material introduction lances.

25. The boiler assembly of claim 19, said fresh sorbent material injection assembly operable to inject fresh sorbent material into at least one injection point selected from the group consisting of said fossil fuel inlet, said boiler chamber, said economizer assembly, said recirculation reactor, and conduit structure there between.

26. The boiler assembly of claim 19, said recovered sorbent material injection assembly operable to inject recovered sorbent material into at least one injection point selected from the group consisting of said fossil fuel inlet, said boiler chamber, said economizer assembly, and conduit structure there between.

27. The method of claim 1, including the step of also introducing powdered activated carbon into said boiler assembly during said burning of said fuel therein.

28. The boiler assembly of claim 19, said fresh sorbent material injection assembly operable to inject powdered activated carbon with said fresh sorbent material.

29. A pollution sorbent material for injection into a fuel-fired boiler assembly to remove Hg emissions from the boiler assembly, said material including therein calcium bromide, sodium carbonate, and a member selected from the group of trona, magnesium oxide, and mixtures thereof.

30. The sorbent material of claim 29, including powdered activated carbon.

31. A method of removing Hg emissions from a fuel-fired boiler assembly comprising the step of introducing the sorbent material of claim 29 into the boiler assembly.

32. The method of claim 30, including the steps of recovering some of said sorbent material in a recirculation reactor, and injecting the recovered sorbent material back into said boiler assembly.

33. The method of claim 31, including the step of introducing said sorbent material without any recovery or recirculation thereof.
